(19) United States
(12) Patent Application Publication
(10) Pub. No.: US 2024/0082109 A1
(43) Pub. Date: Mar. 14, 2024

(54) Sampling Device

(71) Applicant: Typenex Medical, LLC, Chicago, IL (US)

(72) Inventor: Luke A. Westra, Chicago, IL (US)

(21) Appl. No.: 18/269,948

(22) PCT Filed: Dec. 27, 2021
(86) PCT No.: PCT/US2021/065257

§ 371 Date: Jun. 27, 2023

Related U.S. Application Data
(60) Provisional application No. 63/131,013, filed on Dec. 28, 2020.

(51) Int. Cl. A61J 1/20

(52) U.S. Cl. CPC A61J 1/201; A61J 1/2065; A61J 1/2086; A61J 1/2096

(57) ABSTRACT

A sampling device is disclosed. The sampling device includes a cannula and a guide component coupled to the cannula. The cannula includes a top portion and a bottom portion. Moreover, the cannula includes an inner diameter. The bottom portion includes a distal end that is configured to pierce or puncture a cap of a bottle. The guide component includes a lateral portion and a vertical portion. The lateral portion extends radially out from the cannula and the vertical portion is coupled to an outer edge of the lateral portion. The vertical portion extends down from the lateral portion substantially parallel to the cannula and beyond the distal end of the bottom portion.

### CROSS-REFERENCE TO RELATED APPLICATION

The present application claims priority to U.S. Provisional Application No. 63/131,013, filed Dec. 28, 2020, which is hereby incorporated by reference.

### BACKGROUND

Sampling devices are used by healthcare professionals when conducting testing on fluid samples. Frequently, fluid samples are stored and transported in sampling bottles or vials with caps or lids with a pierceable silicone, PTFE, or other rubber compound septum. Lab technicians or other medical professionals conducting tests on such samples are particularly aware of and concerned with contamination of the sample, as well as exposure to the sample.

### SUMMARY

A sampling device provides a variety of features that allows for simple and safe use when preparing a fluid sample for testing. The sampling device is used to directly dispense a desired quantity of a fluid sample from a sampling bottle or vial. Additionally, the sampling device attaches to a variety of related components such as syringes to extract larger volumes of sample and filter caps to prevent exposure to the sample. Certain sampling devices integrate connectors standardized in the medical device industry for use across the healthcare industry, such as Luer lock and Luer slip connectors. Luer connectors are also known as Luer fittings. Luer connectors are part of a standardized system of small-scale tubing connectors used to make secure, generally leak-resistant unions in medical devices and laboratory instruments. Luer connectors described herein may be similar to those provided in ISO 594 (obsolete) or ISO 80369 Small-Bore Connectors For Liquids And Gases In Healthcare Applications, and specifically part 7, ISO 80369-7 Part 7: Connections for Intravascular Or Hypodermic Applications. Part 7 includes example male and female Luer slip connectors and Luer lock connectors.

In a first example embodiment, a device is disclosed. The device may be considered a sampling device or airway needle. The device includes a cannula and a guide component coupled to the cannula. The cannula includes a top portion and a bottom portion. Moreover, the cannula includes an inner diameter. The bottom portion includes a distal end that is configured to pierce or puncture a cap of a bottle. In some examples, a middle portion is between the top portion and the bottom portion and the middle portion may include a textured surface. The top portion includes an outer diameter that is tapered to correspond with a Luer connector. In some examples, the top portion includes a flange adjacent to the middle portion, and a grip area of the device is defined by the flange, the middle portion, and the guide component. The guide component coupled to the cannula includes a lateral portion and a vertical portion. The lateral portion extends radially out from the cannula and the vertical portion is coupled to an outer edge of the lateral portion. The vertical portion extends down from the lateral portion substantially parallel to the cannula and equal to or beyond the distal end of the bottom portion.

In some example embodiments, the inner diameter of the cannula may be constant or substantially constant throughout. Moreover, the top portion may include a flange, collar, and outer tapered surface as part of a connector. Specific to some embodiments, the flange, collar, and outer tapered surface of the top portion may form a Luer connector, and specifically a male Luer lock connector.

In a second example embodiment, a system is disclosed. The system includes a sampling device and a syringe. The sampling device includes a top portion, a middle portion, a bottom portion, a cannula, and a guide component. The top portion of the sampling device is configured to be coupled to a syringe. In some examples, the top portion is configured to be coupled to a syringe, a filter cap, and/or any device with a corresponding connector. The bottom portion of the sampling device includes a distal end and is configured to puncture a cap of a bottle. The middle portion is between the top and bottom portions. The cannula has a constant inner diameter and extends through each of the top portion, the middle portion, and the bottom portion. The guide component is coupled to the cannula and includes a lateral portion and a vertical portion. The lateral portion extends radially out from the cannula while the vertical portion extends down from the lateral portion in a direction substantially parallel to the cannula. Moreover, the vertical portion of the guide component extends past the distal end of the bottom portion of the sampling device. Additionally, the top portion of the sampling device includes a Luer connector that is configured to mate with a corresponding connector included as part of the syringe.

In a third example embodiment, a method is described. The method includes puncturing a septum of a cap of a bottle with a distal end of a bottom portion of a cannula. The cannula has a constant inner diameter and further includes a top portion. The method also includes inserting the bottom portion of the cannula into the bottle such that the cannula is in fluid communication with the bottle. Additionally, the method includes removing a filter cap that is securely connected to a top portion of the cannula. The method also includes securely coupling a syringe to the top portion of the cannula. In some examples, the secure connection between components includes a Luer lock connection between the filer cap/syringe and the top portion of the cannula. In yet another example, the method includes securely coupling a syringe to the top portion when a plunger of the syringe is fully depressed.

In another example embodiment, a system may include various means for manufacturing the sampling device described herein. For example, the sampling device may be injection molded. In some examples, additional machining may be utilized to create additional features after injection molding.

In yet another example embodiment, a method of manufacturing sampling devices is disclosed. Moreover, a method of using sampling devices is disclosed.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

Sampling devices as described herein that safely and effectively facilitate sampling of collected fluid samples and are also cost effective to manufacture at scale are needed and in demand within the healthcare industry.

### BRIEF DESCRIPTION OF THE DRAWINGS

FIG. 1A illustrates a sampling device, in accordance with example embodiments.

FIG. 1B illustrates a side view of a sampling device, in accordance with example embodiments.

FIG. 1C illustrates a section view of a sampling device, in accordance with example embodiments.

FIG. 1D illustrates a top view of a sampling device, in accordance with example embodiments.

FIG. 1E illustrates a bottom view of a sampling device, in accordance with example embodiments.

FIG. 2A illustrates a sampling device with a filter cap attached, in accordance with example embodiments.

FIG. 2B illustrates a section view of a sampling device with a filter cap attached, in accordance with example embodiments.

FIG. 3A illustrates a sampling device coupled to a bottle with a filter cap attached to the sampling device, in accordance with example embodiments.

FIG. 3B illustrates a section view of a sampling device coupled to a bottle with a filter cap attached to the sampling device, in accordance with example embodiments.

FIG. 4 illustrates a section view of a sampling device coupled to a bottle, in accordance with example embodiments.

FIG. 5A illustrates a sampling device coupled to a bottle with a syringe attached to the sampling device, in accordance with example embodiments.

FIG. 5B illustrates a section view of a sampling device coupled to a bottle with a syringe attached to the sampling device, in accordance with example embodiments.

FIG. 6A illustrates a sampling device, in accordance with example embodiments.

FIG. 6B illustrates a section view of a sampling device, in accordance with example embodiments.

FIG. 7A illustrates a sampling device, in accordance with example embodiments.

FIG. 7B illustrates a section view of a sampling device, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

In the healthcare industry, fluid samples are frequently collected in a sampling bottle, vials, or similar vessels. Frequently, a cap that includes a pierceable septum, such as a cap constructed of a silicone, PTFE, or similar polymer, is utilized to maintain the integrity of a sample. When a healthcare professional goes to test a sample, great care is taken to protect the professional from being exposed to the sample, which may include bacteria, viruses, or other pathogens that may be harmful. Similarly, professionals are cautious to not contaminate the sample as to avoid jeopardizing the testing process and results. Additionally, devices commonly used to pierce vial caps (or similar) commonly involve use of exposed sharp-edged equipment, such as needles and needle tips that present a safety risk of injury, such as inadvertent needle sticks. Devices that facilitate a sterile testing process while promoting safety by provide features that protect workers from sharp edges are important to the healthcare industry.

Additionally, many labs carry standardized equipment in order to make the testing process and procedures cost-effective. Conducting these tests while maintaining a sterile environment can be a costly process for healthcare companies. For example, most, if not all, testing components are only used once before being discarded. Thus, many companies will have bulk orders of sterile, one-time-use, standardized equipment. As such, a sampling device that corresponds with existing standards utilized by healthcare companies is of additional value.

Further, manufacturing at scale is also an important consideration for sampling devices. Again, most, if not all, testing done with the sampling devices described herein will be of the nature that the sampling device will be discarded after use. As such, cost-effective manufacturing methods of such sampling devices are important to development of a product. Such manufacturing methods may include injection molding and/or 3D printing sampling devices with minimal tooling, or without the need for secondary processing or assembly steps for example.

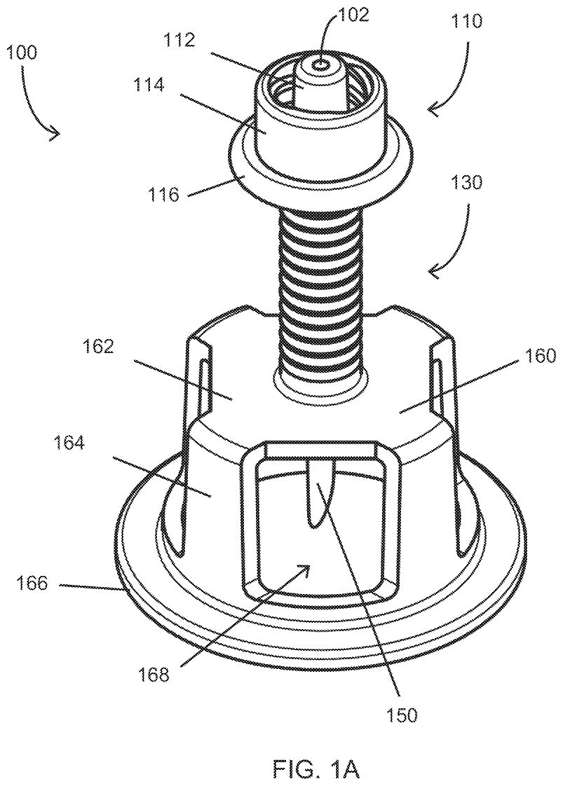

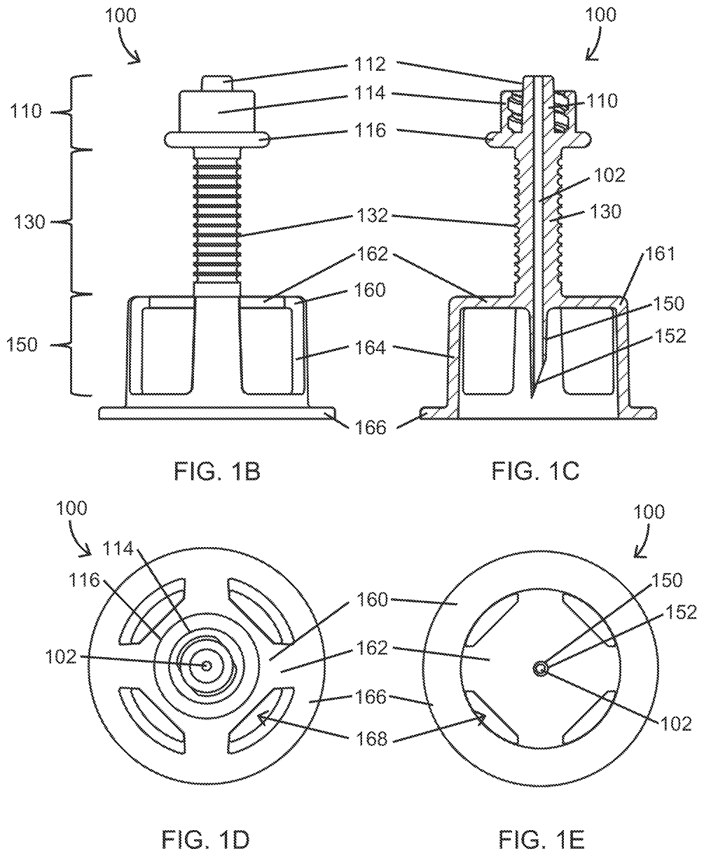

FIGS. 1A, 1B, 1C, 1D, and 1E illustrate a sampling device 100. FIG. 1A provides an isometric perspective view of the sampling device 100. FIG. 1B provides a side view of the sampling device 100. FIG. 1C provides a section of the side view of the sampling device 100. FIG. 1D provides a top view of the sampling device 100. FIG. 1E provides a bottom view of the sampling device 100.

The sampling device 100 includes a cannula 102. The cannula 102 includes a top portion 110, a middle portion 130, and bottom portion 150. Moreover, sampling device 100 includes a guide component 160 coupled to the cannula 102. The cannula 102 has an inner diameter. In some examples, the inner diameter of the cannula 102 is 1.2 mm. In other examples, the cannula 102 diameter may be 2.1 mm+0.8 mm. As depicted, the inner diameter can be constant throughout the cannula 102. For example, the cannula 102 may be 1.2 mm throughout the top portion 110, the middle portion 130, and the bottom portion 150. In another example, the inner diameter may be substantially constant throughout the cannula 102. In some examples where the sampling device 100 is injection molded, the cannula 102 may be formed using a draft that has a taper between 0 and 3 degrees to it. In such an example, the inner diameter may be substantially constant throughout the cannula 102. In another example, the substantially constant inner diameter of the cannula 102 may be 1.2 mm±0.5 mm. In another example, having a substantially constant inner diameter may include the inner diameter being 1.2 mm+0.5 mm. In some examples, the inner diameter of the cannula 102 may be less than an inner diameter provided in ISO 80369.

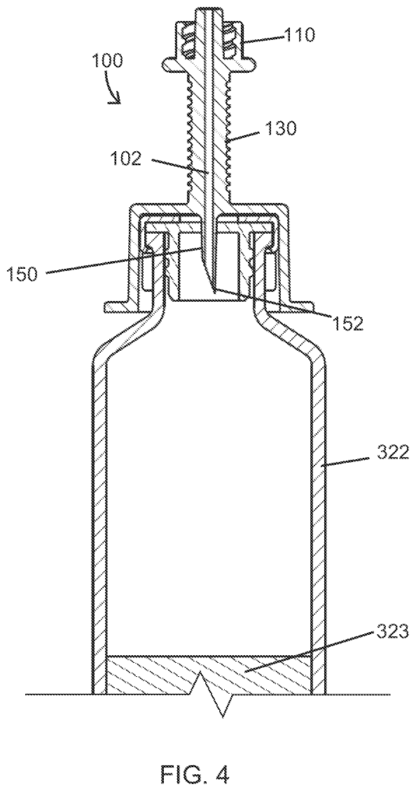

The cannula 102 having a constant, or substantially constant inner diameter allows the sampling device 100 to be used as a dropper. The configuration providing the sampling device 100 as a dropper is shown in FIG. 4 and described herein. Because of the constant or substantially constant inner diameter, there may be laminar flow of a portion of a sample flowing through the cannula 102. Moreover, the constant or substantially constant inner diameter must also be large enough to allow free flow of a portion of a sample from a sample bottle through the sampling device. In addition, in some instances a sample bottle may include silica beads and the inner diameter of the cannula 102 may need to be sized large enough to reduce the likelihood and/or prevent clogging of the cannula 102 by silica beads during use. Further, the constant or substantially constant inner diameter may provide a technician or someone working with the sampling device 100 in a dropper configuration (see e.g., FIGS. 4A and 4B), with increased control of the sample traveling through the cannula 102 and the drops being expressed from the sampling device 100. Within examples, the constant inner diameter of the cannula 102 allows for transfer of droplets of a sample from the sampling device 100 to various substrates used in clinical or laboratory processes, such as glass slides, culture plates and other apparatus known to those skilled in the art.

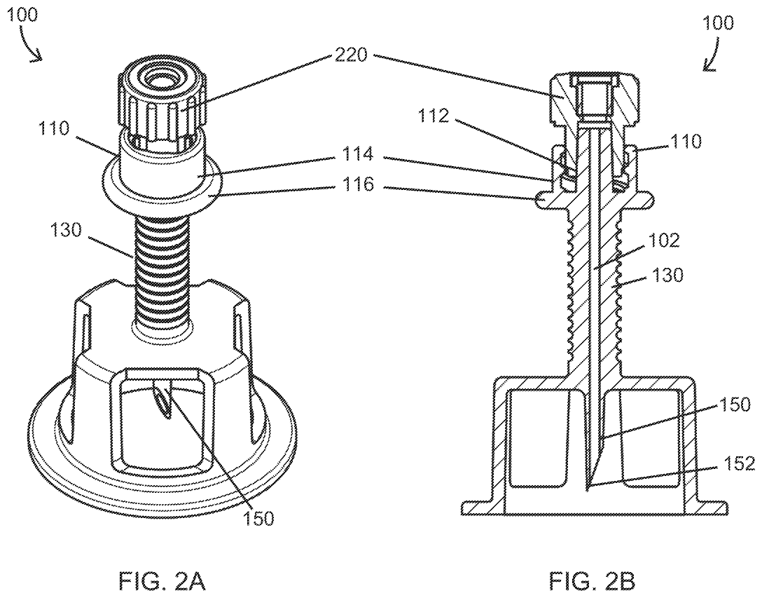

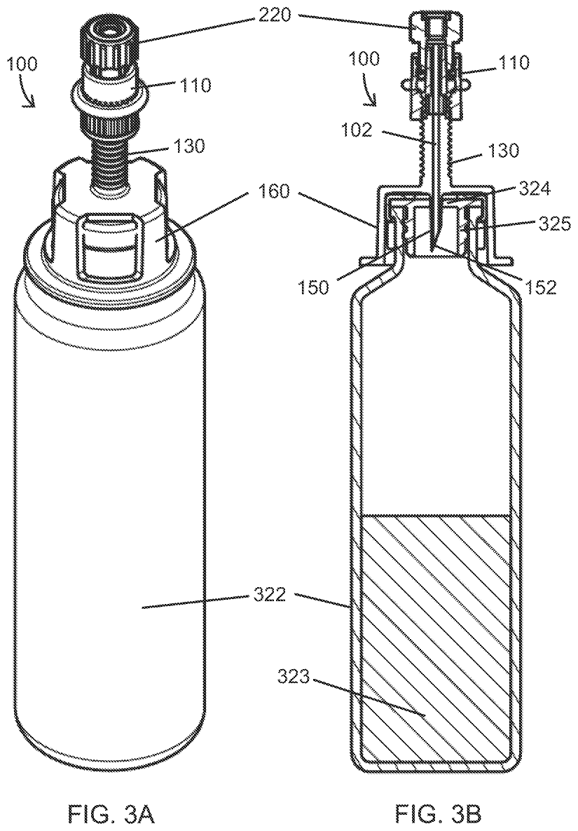

The top portion 110 of the cannula 102 includes an outer tapered surface 112, a collar 114, and a flange 116. In some examples, the outer tapered surface 112 may be considered part of a male Luer connector. As such, the outer tapered surface 112 may include a taper that meets the standards provided in ISO 594 or ISO 80369-7. The outer tapered surface 112 may be tapered or otherwise shaped to correspond with a mating female Luer connector. For example, a filter cap (see FIGS. 2A and 2B) or syringe (see FIGS. 3A and 3B) may include a Luer connector that corresponds to the outer tapered surface 112. The flange 116 may be coupled to or formed as part of the cannula 102 and extend radially outwards from the cannula 102. The collar 114 may be coupled to the flange 116 and extend in a vertical direction up from the flange 116. In this regard, the collar 114 may also be part of the male Luer connector and meet the standards provided in ISO 80369-7, for example.

In the arrangement provided in FIGS. 1A-1E, the top portion 110 includes a male Luer lock connector. As such, the top portion 110 is configured to mate with a corresponding female Luer connector. In some examples, the corresponding female Luer connector may be a Luer slip connector or Luer lock connector. A Luer slip connector provides an interference or friction fit. A Luer lock connector includes threading on both the male and female parts such that the Luer lock connector provides a connection that is more resistant to axial separation than the Luer slip connector. In this regard, a Luer lock connector may provide a more secure connection between components.

As shown in FIGS. 1A-1E, the collar 114 includes threading. The threading of the collar 114 may meet the standards of a Luer lock connection as provided by ISO 80369-7, for example. In some examples, the threading of the collar 114 (and/or one or more other related component) may not meet the standards of a Luer connection. The collar 114 may surround at least a portion of the top portion 110, such as a portion of the outer tapered surface 112. In this regard, the outer tapered surface 112 may extend beyond the collar 114 in the vertical direction (as shown in FIGS. 1B and 1C, specifically).

The middle portion 130 of the cannula 102 is coupled to the top portion 110 of the cannula 102. Moreover, the middle portion 130 is coupled between the top portion 110 and the bottom portion 150. In some examples, the middle portion 130 is adjacent to the flange 116 of the top portion 110. The middle portion 130 may include a textured surface 132. The textured surface 132 may provide ribbing or other texture that provides a user additional grip when holding and using the sampling device 100. In some examples, the middle portion 130 is generally cylindrical. In other examples, the middle portion 130 may have an alternative geometry, such as conical or rectangular. In an example conical embodiment, the middle portion 130 may extend down from an outer edge of the flange 116.

As mentioned above, the bottom portion 150 is coupled to the middle portion 130 of the cannula 102. The bottom portion 150 is configured to be inserted into a bottle, such as a vial or culture/sample bottle. The bottom portion 150 may include a distal end 152. The distal end 152 may include one or more bevels. By beveling the distal end 152, it may require less force to insert at least a portion of the bottom portion 150 of the cannula 102 through a septum of a lid of a bottle (not shown in FIGS. 1A-1E). The bottom portion 150 may also be tapered such that an outer diameter of the bottom portion 150 is smaller at the distal end 152 than at a proximate end near the middle portion 130. In some examples, the bottom portion 150 has a constant taper form the middle portion 130 to the distal end 152.

The sampling device 100 also includes the guide component 160. In some examples, the guide component 160 may be coupled to the bottom portion 150 of the cannula 102. In other examples, the guide component 160 may be coupled to the middle portion 130. The middle portion 130 may be considered the portion of the cannula 102 between the flange of the top portion 110 and the guide component 160.

The guide component 160 includes a lateral portion 162 that extends radially out from the cannula 102. For example, the lateral portion 162 may extend radially out from the bottom portion 150 of the cannula 102. In some examples, the middle portion 130 may be the portion of the cannula 102 between the flange of the top portion 110 and the lateral portion 162 of the guide component 160. In such examples, the flange 116, the middle portion 130 (including the textured surface 132 thereof), and the lateral portion 162 of the guide component 160 define a grip area. The grip area is the area configured to be held by a user of the sampling device 100. Holding the grip area of the sampling device 100 may provide a user leverage when inserting the sampling device 100 into a bottle and then using the sampling device 100 to extract a portion of a sample.

The guide component 160 further includes a vertical portion 164 coupled to an outer edge 161 of the lateral portion 162. The vertical portion 164 may extend down from the lateral portion 162 in a direction that is substantially parallel to the cannula 102. Moreover, the vertical portion 164 may extend vertically down past the distal end 152 of the bottom portion 150. In this regard, the guide component 160 may extend past the distal end 152 of the bottom portion 150 of the cannula 102. Thus, the guide component 160 may protect a user from coming in contact with the distal end 152. Particularly, as described above, the distal end 152 may include a beveled edge that could be sharp. As such, by extending the vertical portion 164 past the distal end 152, the guide component 160 may reduce the likelihood that a user may injure themselves when using the sampling device 100.

The guide component 160 may also include an outer flange 166. The outer flange 166 may be coupled to the vertical portion 164 and extend radially outwards away from the cannula 102. The outer flange 166 may provide support to the guide component 160. Moreover, the outer flange 166 may allow for better control and protection when using the sampling device 100. The outer flange 166 may also allow for the sampling device 100 to be stored in a vertical arrangement.

In some examples, such as depicted in FIGS. 1A-1E, the guide component 160 may also include one or more cutouts 168. In some examples, the guide component 160 may be opaque. The cutouts 168 may provide visual access to the distal end 152 of the bottom portion 150. As such, a user may have undistorted and/or direct view of the distal end 152 when puncturing and inserting the sampling device 100 into a sample bottle.

Within examples, the guide component 160 assists a user of the sampling device to locate the distal end 152 of the bottom portion 150 at or near the center of a lid of a sample bottle. For example, the vertical portion 164 of the guide component 160 may limit radial alignment between the sampling device 100 and a sample bottle. For example, a lid and/or a neck of the bottle may be aligned with the distal end 152 by the guide component 160. Further, as described above, the guide component 160 may provide visual access to a user to the distal end 152, which may be beveled and sharp to user.

FIGS. 2A and 2B illustrate the sampling device 100 with a filter cap 220 coupled to the top portion 110. The filter cap 220 may also be considered a venting cap. The filter cap 220 may include filtering features, material or media that are appropriately sized to allow for gas to pass through a filter included in the filter cap 220. In some embodiments, the filter material can be a hydrophobic material with a pore size of approximately 3 microns. Pore sizes both smaller or larger can be selected by those skilled in the art. A sample bottle may have a pressure that is greater than an ambient pressure within a lab. As such, when the sampling device 100 is coupled to a sample bottle, the internal pressure of the bottle is released through the cannula 102 and the air of the lab including the user may be exposed to any air and particles released from the sample bottle. In some instances, the air within the sample bottle may include contaminates that may include bacteria, virus, or other pathogen. To reduce potential exposure, the filter cap 220 is installed on the top portion 110 before inserting the bottom portion 150 into a sample bottle. Once connected the sample bottle, the filter cap 220 may filter out any pathogens from the sample bottle when the pressure within the sample bottle equalizes with the ambient pressure.

The filter cap 220 may connect to the top portion 110 of the sampling device 100 via a Luer connector that corresponds to the Luer connector of the top portion 110. For example, the filter cap 220 depicted in FIGS. 2A and 2B includes a female Luer slip connection configured to mate with the outer tapered surface 112 of the top portion 110. In other examples, the filter cap may includes a female Luer lock connector and also include threading that mates with the threading of the collar 114. After the sampling device 100 is coupled to a sample bottle by inserting the bottom portion 150 into the sample bottle, the filter cap 220 may be removed from the sampling device 100.

Continuing with the figures, FIGS. 3A and 3B depict the sampling device 100 with the filter cap 220 coupled to a sample bottle 322. The sample bottle 322 may also be a vial, test tube, specimen tube, a blood culture bottle, or other similar bottle regularly used to conduct testing as described herein. The bottle 322 may take on a variety of shapes and sizes and be known to a person of ordinary skill in the art (“POSA”) without departing from the scope of this disclosure. A fluid sample 323 is included with the bottle 322.

Within examples, the distal end 152 of the bottom portion 150 of the cannula 102 may puncture a septum 324 of a cap 325 of the sample bottle 322. Then at least a portion of the bottom portion 150 may be inserted into the bottle such that the cannula 102 is now in fluid communication with the sample 323 within the bottle 322.

In another example, before puncturing the septum 324, the guide component 160 may align the distal end 152 of the bottom portion 150 at or near a center of the cap 325. Moreover, after puncturing the septum 324, the filter cap 220 may filter out any contaminates that were present in the bottle 322 such that the contaminates remain within bottle 322 and/or cannula 102.

Continuing with the figures, FIG. 4 depicts the sampling device 100 coupled to the bottle 322, but without the filter cap 220. As such, the filter cap 220 has been removed after at least a portion of the bottom portion 150 was inserted through the cap 325 into the bottle 322. As previously described, in some examples, the filter cap 220 may include a Luer lock connection providing a secure connection to the top portion 110 of the cannula 102 such that it is less likely to become accidently disengaged from the sampling device 100. In such an example, the filter cap 220 may have to be unscrewed from the top portion 110 of the sampling device 100. In other examples, the filter cap 220 includes a Luer slip connector and can be removed by axially separating the filter cap 220 from the sampling device 100.

In the configuration provided in FIG. 4, i.e., the sampling device 100 coupled to the bottle 322 without the filter cap 220 or other attachment, the sampling device 100 may be configured to be used as a dropper. For example, a user may grip the middle portion 130 of the sample device 130 and turn the combined sampling device 100 and bottle 322 on their side or invert such that the sample 323 is allowed to pass through the inner diameter of the cannula 102 of the sampling device 100. The user then may balance out the sample 323 present in the bottle 322 as it reaches the top of the top portion 110 of the cannula 102 where a drop of the sample 323 will form and can be transferred for testing. No other device or component is required to use the sampling device 100 as a dropper in this dropper configuration.

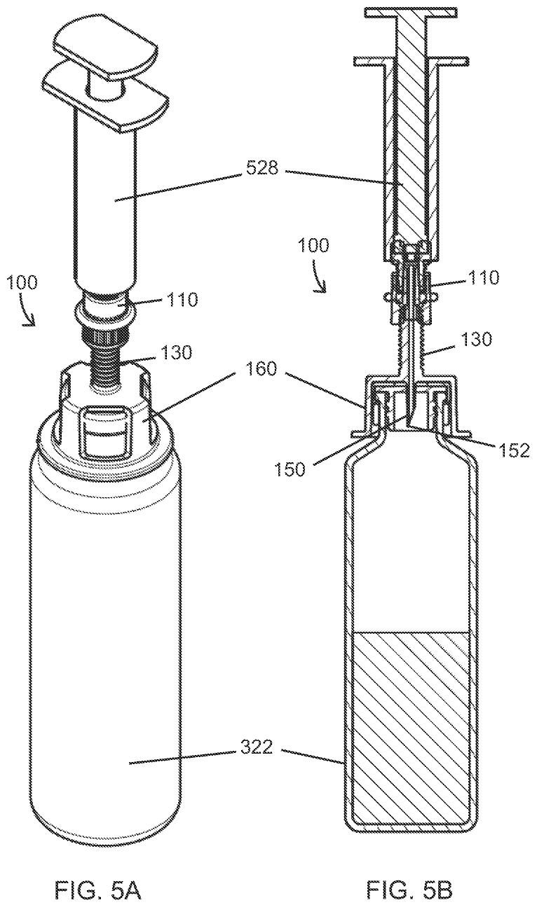

FIGS. 5A and 5B provide the sampling device 100 coupled to the bottle 322 and also coupled to a syringe 528. Within examples, without having to include any other components, the syringe 528 can be coupled to the sampling device 100, and specifically the top portion 110 of the sampling device 100. For example, the syringe 528 may include a Luer connection, including either a Luer lock connection (as shown) or a Luer slip connection, that corresponds to the Luer connection of the top portion 110. For example, a female Luer connector of the syringe may correspond and mate with the outer tapered surface 112 of the top portion 110. Moreover, a female Luer lock connector of the syringe may also include threading configured to mate with the threading of the collar 114 of the top portion 110. In some examples where the top portion 110 includes a male Luer lock connector and the syringe 528 includes a female Luer lock connector, a secure connection between the syringe 528 and sampling device 100 may be created when the connector of the syringe 528 is screwed into the top portion 110 of the sampling device 100. In the configuration provided in FIGS. 5A and 5B, a portion of the sample 323 may be drawn into the syringe 528 and then be transferred for testing and analysis.

A person of skill in the art would understand that the sampling device 100 provides flexibility to be coupled to a variety of other components that include Luer connectors. Moreover, a person of skill in the art would recognize the various advantages of a sampling device that provides secure connections to limit the potential of any contamination of and exposure to the sample.

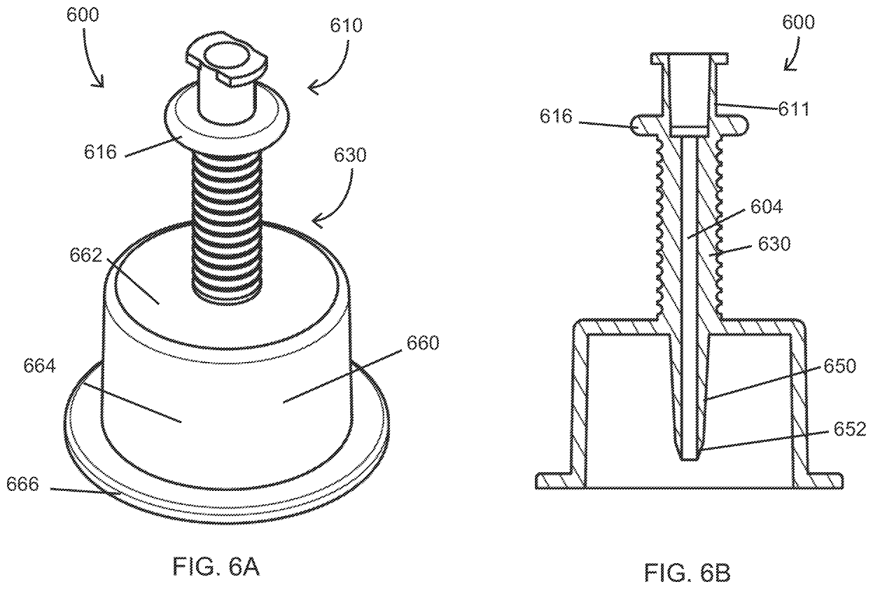

FIGS. 6A and 6B include a sample device 600. The sampling device 600 may be similar in form and function as the sampling device 100 described herein. However, the sampling device 600 may include features or components that are different than the sampling device 100.

The sampling device 600 may include a top portion 610, a middle portion 630, a bottom portion 650, and a guide component 660. Moreover, the sampling device 600 includes a cannula 604 that may have a constant or substantially constant diameter. In the configuration provided in FIGS. 6A and 6B, the cannula 604 may extend through the middle portion 630 and the bottom portion 650. The bottom portion 650 includes a distal end 652.

The top portion 610 includes a female connector 611 and a flange 616. In some examples, the female connector 611 may meet the specification of a standard Luer connector under ISO 80369-7, and specifically a female Luer slip connector. As such, a corresponding filter cap and syringe may include a male Luer connector that corresponds to the female connector 611.

The guide component 660 includes a lateral portion 662, a vertical portion 664, and an outer flange 666. As shown in FIGS. 6A and 6B, the vertical portion 664 does not include any cutouts and is generally cylindrical. In such examples, the guide component 660 may be constructed from an opaque resin or plastic such that a user can see the distal end 652 of the bottom portion 650 through the guide component 660.

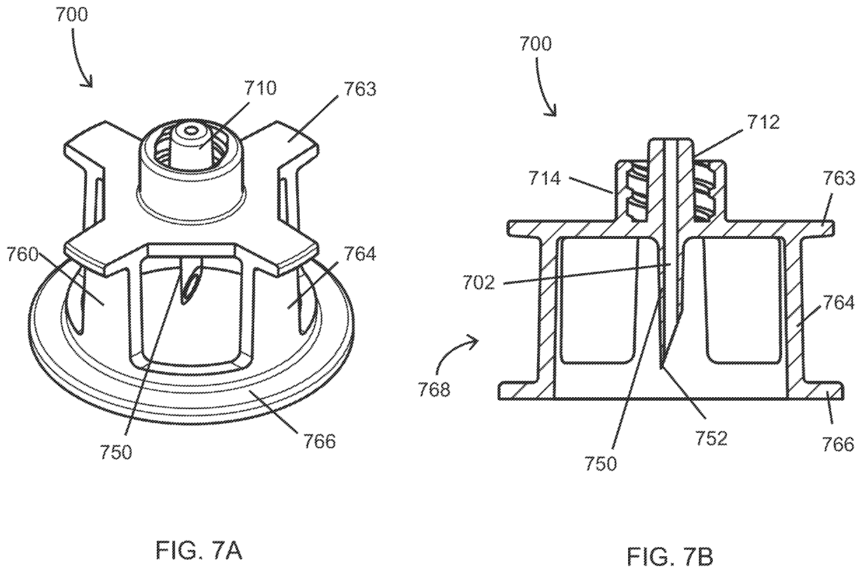

FIGS. 7A and 7B include a sample device 700. The sampling device 700 may be similar in form and function as the sampling device 100 described herein. However, as depicted, when compared to the sampling device 100, the sampling device 700 does not include the middle portion 130.

The sampling device 700 includes a cannula 702, a top portion 710, and a bottom portion 750. The top portion 710 has an outer tapered surface 712. In some examples, the outer tapered surface 712 may correspond with a mating Luer connector. For example, the outer tapered surface 712 may be part of a male Luer connector and meet the outer conical dimensions provided in ISO 80369. The cannula 702 has an inner diameter and the inner diameter may be smaller than the inner diameter dimensions provided in ISO 80369. For example, the inner diameter might be approximately 1.2 mm, or 1.2+0.5 mm in some examples. The inner diameter of cannula 102 may be substantially constant throughout the top portion 710 and the bottom portion 750.

The sampling device 700 further includes a guide component 760. The guide component 760 may be coupled to the cannula 702. The guide component 760 includes a lateral flange 763 that extends radially out from the cannula 702. A collar 714 extends vertically up from the lateral flange 763. The collar 714 surrounds a portion of the top portion 710. Moreover, the collar 714 surrounds a portion of the outer tapered surface 712. In other aspects, the outer tapered surface 712 extends beyond the collar 714. In some examples, because the outer tapered surface 712 extends beyond the collar 714, the sampling device 700 may function as a dropper without any other attachment to the top portion 710.

The guide component 760 further includes a vertical portion 764. As depicted, the vertical portion 764 extends down from the lateral flange 763. A distal flange 766 may be coupled to a distal end of the vertical portion 764. Also, the distal flange 766 may extend radially out from the vertical portion 764. As shown, the lateral flange 763, particularly a portion of the lateral flange 763 that extends radially past the vertical portion 764, the vertical portion 764, and the distal flange 766 define a channel 768. The channel 768 may surround the bottom portion 750. Moreover, the channel 768 may provide a grip area. The grip area may be a defined location for a user to grip the sampling device 700 that protects a user from accidently coming in contact with the cannula 702. The lateral flange 763, or a portion thereof, and the distal flange 766 may help the user insert the sampling device 700 into a sample bottle, use the sampling device 700 as a dropper, and remove the sampling device 700 from the sample bottle. The lateral flange 763 and the distal flange 766 may prevent a user's fingers and hand from slipping off the sampling device 700.

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A device, comprising:
a cannula having an inner diameter, the cannula comprising:
a top portion comprising a surface that is tapered to correspond with a Luer connector;
a bottom portion, wherein a distal end of the bottom portion is configured to pierce a cap of a bottle; and
a guide component coupled to the cannula, the guide component comprising:
a lateral portion that extends radially out from the cannula; and
a vertical portion coupled to an outer edge of the lateral portion, wherein the vertical portion extends down from the lateral portion substantially parallel to the cannula and past the distal end of the bottom portion.

2. The device of claim 1, wherein the inner diameter is constant throughout the cannula.

3. The device of claim 2, wherein the constant inner diameter of the cannula allows for transfer of droplets of a sample.

4. The device of claim 1, wherein a collar surrounds at least a portion of the top portion of the cannula, wherein the collar comprises threading that is configured to couple to a syringe, and wherein a surface of the top portion of the cannula is tapered to correspond with a connector of the syringe.

5. The device of claim 4, wherein the top portion of the cannula extends above the collar.

6. The device of claim 1, wherein a grip area is defined, at least in part, by the lateral portion of the guide component.

7. The device of claim 1, wherein the tapered surface of the top portion of the cannula is an outer surface and the top portion of the cannula comprises a portion of a male Luer slip connector.

8. The device of claim 1, wherein the tapered surface of the top portion of the cannula is an outer surface and the top portion of the cannula comprises a portion of a male Luer lock connector.

9. The device of claim 1, wherein the tapered surface of the top portion of the cannula is an interior surface and the top portion of the cannula comprises a portion of a female Luer lock connector.

10. The device of claim 1, wherein the top portion of the cannula is configured to couple with each of a venting cap and a syringe.

11. The device of claim 1, wherein the guide component locates the distal end of the bottom portion of the cannula near the center of a vial cap.

12. The device of claim 1, wherein the guide component further comprises a circular flange portion coupled to a distal end of the vertical portion.

13. The device of claim 1, wherein the guide component comprises a plurality of cutouts such that the distal end of the bottom portion of the cannula is visible.

14. The device of claim 2, wherein the constant inner diameter is 1.2 millimeters±0.5 millimeters.

15. A system, comprising:
a sampling device, comprising:
a top portion configured to be coupled to a syringe;
a bottom portion, wherein a distal end of the bottom portion is configured to puncture a cap of a bottle;
a cannula having a constant inner diameter, wherein the cannula extends through the top portion and the bottom portion; and
a guide component coupled to the cannula, the guide component comprising:
a lateral portion that extends radially out from the cannula; and
a vertical portion coupled to an outer edge of the lateral portion, wherein
the vertical portion extends down from the lateral portion substantially parallel to the cannula and past the distal end of the bottom portion; and
the syringe, wherein the top portion of the sampling device comprises a Luer connector configured to mate with a corresponding connector of the syringe.

16. The system of claim 15, further comprising,
a filter cap, wherein the filter cap is couplable to the top portion of the sampling device, wherein the filter cap is configured to filter contaminants when the distal end of the bottom portion of the sampling device punctures the cap.

17. A method, comprising:
puncturing, by a distal beveled end of a bottom portion of a cannula, a septum of a cap of a bottle, wherein the cannula has a constant inner diameter and comprises the bottom portion and a top portion, wherein the top portion of the cannula comprises an outer surface that is tapered to correspond with a Luer connector;
inserting the bottom portion of the cannula into the bottle such that the cannula is in fluid communication with a sample within the bottle; and
removing a filter cap securely coupled to a top portion of the cannula.

18. A device, comprising:
a cannula comprising:
a top portion having an inner surface tapered to correspond with a female Luer connector;
a bottom portion coupled to the top portion, wherein a distal end of the bottom portion is configured to pierce a cap of a bottle; and
a guide component comprising:
a lateral flange that extends radially out from the cannula;
a vertical portion coupled to the lateral flange, wherein the vertical portion extends down from the lateral portion substantially parallel to the cannula and past the distal end of the bottom portion; and
a distal flange that extends radially out from a distal end of the vertical portion, wherein the lateral flange, vertical portion, and the distal flange define a channel.

19. The device of claim 18, wherein the channel surrounds the bottom portion of the cannula.

20. The device of claim 19, wherein the channel provides a grip area.
